(19) United States
(12) Patent Application Publication
(10) Pub. No.: US 2008/0314874 A1
(43) Pub. Date: Dec. 25, 2008

(54) Vacuum Interrupter

(75) Inventors: Andreas Lawall, Berlin (DE); Klaus Oberndorfer, Berlin (DE); Ulf Schumann, Berlin (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, Munich (DE)

(21) Appl. No.: 12/096,971

(22) PCT Filed: Dec. 12, 2005
(86) PCT No.: PCT/DE2005/002245

§ 371 Date: Jun. 11, 2008

(51) Int. Cl. H01H 33/662

(52) U.S. Cl. 218/136

(57) ABSTRACT

A vacuum interrupter has a tubular insulating body and a contact system with a moving contact and a fixed contact each connected to power supply bolts, which are passed out of the vacuum interrupter in a vacuum-tight manner. A control electrode is DC-connected to the fixed-contact power supply bolt. A damping shield, which is arranged on the insulating body, is conductive and overlaps the control electrode in an axial direction. The vacuum interrupter has good shielding properties while at the same time improving the dielectric insulation. The control electrode extends out in the form of a toroid in the region of overlap with the damping shield, the damping shield is drawn inwards so as to correspond to the toroid, and the fixed-contact power supply bolt is constricted so as to correspond to the contour of the damping shield and the constriction is fitted such that the drawn-in region of the damping shield extends around the constriction.

The invention relates to a vacuum interrupter having a tubular insulating body and having a contact system comprising a moving contact and a fixed contact each of which are connected to current supply bolts which are passed out of the vacuum interrupter in a vacuum-tight manner, and as well as having a control electrode, which is galvanically connected to the fixed-contact current supply bolt and having a conductive vapor shield which is arranged on the insulating body and overlaps the control electrode in an axial direction.

A vacuum interrupter such as this is disclosed in DE 92 11 970 U1. The vacuum interrupter disclosed there has a vapor shield which is held on a metallic intermediate ring on the insulating body of the vacuum interrupter and axially overlaps a control electrode, which is galvanically connected to a flange, so that the vapor shield forms a plasma barrier to the ceramic insulating body, thus preventing vaporization of the insulating body as a result of switching operations with an arc. The control electrodes and the vapor shield are also used for potential control in the vacuum interrupter, in order to improve the dielectrically insulating characteristics.

The object of the present invention is to provide a vacuum interrupter of the type mentioned initially which has better dielectric insulation characteristics.

According to the invention, this object is achieved in that
the control electrode ends with the vapor shield in the form of a toroid in the overlap area,
the vapor shield is drawn inward corresponding to the toroid, and
the fixed-contact current supply bolt is constricted corresponding to the contour of the vapor shield, and the constriction is applied such that the drawn-in area of the vapor shield extends around the constriction.

The control electrode which is provided according to the invention and ends with the vapor shield in the form of a toroid in the overlap area advantageously improves the dielectric strength in the area of the fixed-contact current supply bolt, with the vapor shield, which is drawn inwards corresponding to the toroid, and the fixed-contact current supply bolt, which is constricted in a corresponding manner to the contour of the vapor shield, as well as the arrangement of the constriction additionally ensuring a homogeneous field profile.

Against the background of the vacuum interrupter according to DE 92 11 970 U1, the invention likewise also relates to a vacuum interrupter having a tubular insulating body and a contact system comprising a moving contact and a fixed contact each of which are connected to current supply bolts which are passed out of the vacuum interrupter in a vacuum-tight manner, and as well as having a control electrode, which is galvanically connected to the moving-contact current supply wall and having a conductive vapor shield which is arranged on the insulating body and overlaps the control electrode in an axial reaction.

In order to achieve the stated object, according to the invention,
the control electrode ends with the vapor shield in the form of a toroid in the overlap area,
the vapor shield is drawn inward corresponding to the toroid, and
the moving contact current supply bolt has a waist such that the drawn-in area of the vapor shield extends around the waist when the contact system is in the open position.

The control electrode, which is provided according to the invention and ends with the vapor shield in the form of a toroid in the overlap area, advantageously improves the dielectric strength in the area of the moving-contact current supply bolt, with the vapor shield which is drawn inwards corresponding to the toroid and the waist of the moving-contact current supply bolt additionally ensuring a homogeneous field profile when the contact system is open.

In a further refinement, the waist of the moving contact current supply bolt has a contour which corresponds to that of the vapor shield which is drawn inwards. A waist such as this provides a simple capability to form a homogeneous field profile when the contact system is open.

In another preferred refinement, the waist of the moving-contact current supply bolt is lengthened in the axial direction away from the moving contact by at most a length which corresponds to a movement distance of the moving contact. Lengthening of the waist of the moving-contact current supply bolt in this way results in the field profile being made homogeneous during the opening process of the contact system.

In one preferred embodiment, the control electrode extends from the insulating body in the direction of the vapor shield. In a refinement of the control electrode such as this, the toroid can advantageously be formed with a larger radius.

In one preferred embodiment, the vapor shield is composed of stainless steel. Stainless steel is an advantageous material since it reduces the induction of eddy currents in the vapor shield while having adequate conductivity.

The invention will be explained using one exemplary embodiment and with reference to the attached drawing, in which:

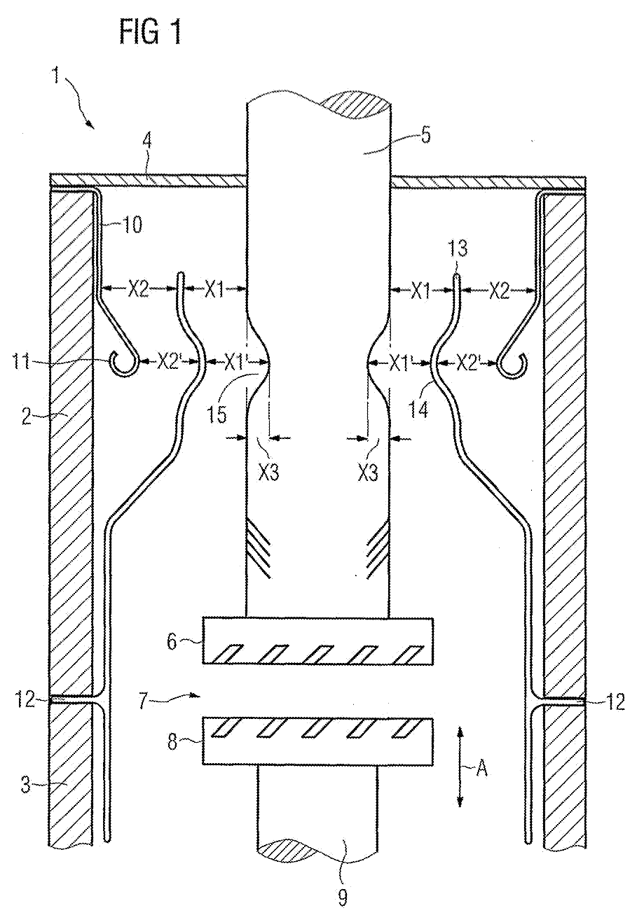

FIG. 1 shows a cross-sectional view in the area of the fixed-contact current supply bolt of a vacuum interrupter according to the invention; and

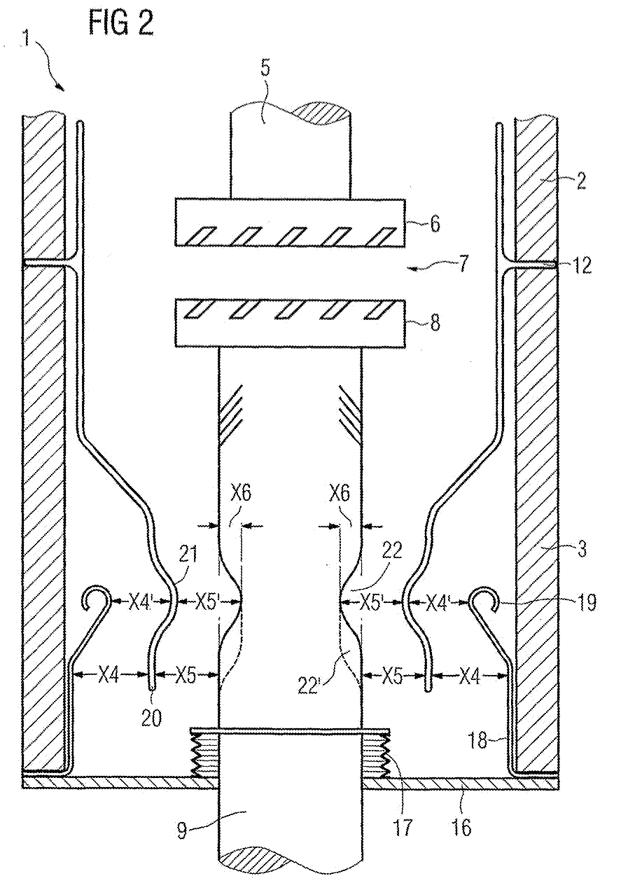

FIG. 2 shows a further cross-sectional view in the area of the moving-contact current supply bolt of a vacuum interrupter according to the invention.

FIG. 1 shows a vacuum interrupter 1 with a tubular insulating body which has hollow-cylindrical ceramic insulators 2 and 3 and is closed in a vacuum-tight manner on one end face by means of a metallic flange 4. A fixed-contact current supply bolt 5 extends through the flange 4, is connected outside the vacuum interrupter to a connecting line (which is not illustrated in the figures), is passed through the flange 4 in a vacuum-tight manner, and has a fixed contact 6 of a contact system 7 in the interior of the vacuum interrupter 1. The contact system 7 also has a moving contact 8, which is likewise connected by means of a current supply bolt 9 outside the vacuum interrupter 1 to a further connecting line, which is not illustrated in the figures. The moving contact 8 is arranged on the vacuum interrupter in a vacuum-tight manner and such that it can move, so that the moving contact 8 can be moved via a drive apparatus (which is not shown in the figures) in the direction of the movement arrow A towards the fixed contact 6 and away from the fixed contact 6, in order to correspondingly make or to break a conductive link. A control electrode 10 is arranged between the flange 4 and the ceramic insulator 2 and is galvanically connected to the flange 4. The free end 11 of the control electrode 10 is curved in the form of a toroid in the direction of the ceramic insulator 2 in the interior of the vacuum interrupter 1. A vapor shield 12 composed of a conductive material, for example stainless steel, is mounted in an insulating manner between the two ceramic insulators 2 and 3, such that the vapor shield 12 is not at a fixed potential. The free end 13 of the vapor shield 12 overlaps the control electrode 10 in the axial direction of the vacuum interrupter 1 and has a drawn-in area 14 in the overlap area, which is arranged opposite a constriction 15 in the current supply bolt 5. The constriction 15 in the current supply bolt 5, the drawn-in area 14 of the vapor shield 12, and the free end 11, which is curved in a toroidal shape, of the control electrode 10 are arranged at the same height in the axial direction of the vacuum interrupter 1.

In the vacuum interrupter 1 of the exemplary embodiment according to the invention, the control electrode 10 is galvanically connected to the current supply bolt 5 via the metallic flange 4 and is therefore at the same potential as the current supply bolt 5 of the fixed contact 6. The control electrode 10 is therefore used to control the potential along the ceramic insulators. The vapor shield 12 is used as a plasma barrier to the ceramic, in order to protect the ceramic insulators 2, 3 against vaporization during switching operations in which a current is flowing and an arc may be struck. In order to ensure the best possible dielectric insulation in the vacuum interrupter 1, the vapor shield 12 is formed from a conducive material and is shaped such that emerging electrical fields are as homogeneous as possible in the interior of the vacuum interrupter 1. In the vacuum interrupter 1 according to the invention, the current supply bolt 5 therefore has the constriction 15 in the area in which the control electrode 10 has a toroidal curvature towards the ceramic insulator 2, and the vapor shield 12 likewise has a drawn-in area 14 whose geometry corresponds to the toroid of the control electrode. The contour of the constriction 15 in the current supply bolt 5 corresponds to the drawn-in area 14 of the vapor shield 12. A constriction 15 such as this and a corresponding drawn-in area 14 ensure that the distances X1 between the current supply bolt 5 and the vapor shield 12, as well as X2 between the vapor shield 12 and the control electrode 10, have approximately the same value throughout the entire overlap area, and, particularly in the area of the constriction 15, the distances X1′ between the current supply bolt 5 and the drawn-in area 14 of the vapor shield 11, and X2′ between the drawn-in area 14 of the vapor shield 12 and the control electrode 10, likewise correspond approximately to the values X1 and X2, respectively. The insulating arrangement of the vapor shield 12 results in the potential on them being about half the potential on the control electrode 10 and the current supply bolt 5. The geometric arrangement according to the invention with the constriction 15, the drawn-in area 14 and the vapor shield 12 and the toroidal curvature 11 of the control electrode 10 in this case ensure that the resulting electrical field ranks as homogeneously as possible over the entire area. An arrangement such as this therefore minimizes the probability of a flashover between the individual elements of the vacuum interrupter 1, and therefore improves the dielectric insulation. The depth of the constriction 15 is in this case chosen such that it increases the total resistance of the interrupter only insignificantly. In the arrangement according to the invention, the dielectric insulation path length is increased by a distance X3 corresponding to the depth of the constriction 15 in the current supply bolt 5.

FIG. 2 shows a further view of the exemplary embodiment of the vacuum interrupter 1 with the contact system 7 open. The moving-contact current supply bolt 9 is passed out of the vacuum interrupter 1, in a vacuum-tight manner and such that it can move, through a metallic end plate 16 by means of a bellows 17, and is coupled to a drive unit (which is not illustrated in the figures) in order to initiate a movement. A control electrode 18 is galvanically connected to the end plate 17 and ends in a toroidal shape at its end 19. The free end 20 of the vapor shield 12 overlaps the control electrode 18 in the axial direction of the vacuum interrupter 1, and has a drawn-in area 21 inwards in the overlap area, which is arranged opposite a waist 22 in the current supply bolt 9. The waist 22 in the current supply bolt 9, the drawn-in area 21 of the vapor shield 12, and the free end 19, which is curved in a toroidal shape, of the control electrode 18 area arranged at the same height in the axial direction of the vacuum interrupter 1.

The waist 22 in the moving-contact current supply bolt 9 is in this case arranged such that, when the contact system 7 is open, the vacuum interrupter 1 is opposite the drawn-in area 21 of the vapor shield 12. This results in homogenization of the field when the contact system 7 is open, since the distances X5 between the current supply bolt 9 and the vapor shield 12 as well as X4 between the vapor shield 12 and the control electrode 18 have approximately the same value throughout the entire overlap area, and, particularly in the area of the waist 22, the distances X5′ between the current supply bolt 9 and the drawn-in area 21 of the vapor shield 12, as well as X4′ between the drawn-in area 21 of the vapor shield 12 and toroidal end 19 of the control electrode 18, likewise corresponds approximately to the respective values X5 and X4. The depth X6 of the waist 22 is in this case likewise chosen such that the overall resistance of the interrupter is increased only insignificantly. In the arrangement according to the invention, the dielectric insulation path is increased by a distance X6 corresponding to the depth of the waist 22 in the moving-contact current supply bolt 9.

However, the waist 22 in the moving-contact current supply bolt 9 can also be lengthened in the movement direction, for example by a length which corresponds to the rated movement of the vacuum interrupter, and therefore to the movement distance of the moving contact. A lengthened waist 22′ such as this is shown by dashed lines in FIG. 2, and serves to homogenize the electrical field even during a disconnection process of the contact system.

### LIST OF REFERENCE SYMBOLS

1 Vacuum interrupter
2, 3 Ceramic insulators
4 Metallic flange
5 Fixed-contact current supply bolt
6 Fixed contact
7 Contact system
8 Moving contact
9 Current supply bolt
10 Control electrode
11 End curved like a toroid
12 Vapor shield
13 Free end
14 Drawn-in area
15 Constriction
16 Metallic end plate
17 Bellows
18 Control electrode
19 End curved like a toroid
20 Free end
21 Drawn in area
22 Waist
22′ Waist
A Movement arrow
X1, X1′ Distance between the fixed-contact current supply bolt and the vapor shield
X2, X2′ Distance between the control electrode and the vapor shield
X3 Constriction depth
X4, X4′ Distance between the control electrode and the vapor shield
X5, X5′ Distance between the moving-contact current supply bolt and the vapor shield
X6 Waist depth

1-6. (canceled)

7. A vacuum interrupter, comprising:
a tubular insulating body;
a contact system including a moving contact connected to a current supply bolt and a fixed contact connected to a fixed-contact current supply bolt, said current supply bolts being passed out of the vacuum interrupter in a vacuum-tight manner;
a control electrode galvanically connected to said fixed-contact current supply bolt and a conductive vapor shield disposed on said insulating body and overlapping said control electrode in an axial direction to form an overlap region;
said control electrode forming a toroid end in said overlap region with said vapor shield;
said vapor shield having a drawn-in region drawn inwardly in accordance with the toroidal shape of said control electrode; and
said fixed-contact current supply bolt having a constriction corresponding to a contour of said vapor shield, with said drawn-in region of said vapor shield extending around said constriction.

8. The vacuum interrupter according to claim 7, wherein said control electrode extends from said insulating body in a direction of said vapor shield.

9. The vacuum interrupter according to claim 7, wherein said vapor shield is formed of stainless steel.

10. A vacuum interrupter, comprising:
a tubular insulating body;
a contact system including a moving contact connected to a moving-contact current supply bolt and a fixed contact connected to a fixed-contact current supply bolt, said current supply bolts being passed out of the vacuum interrupter in a vacuum-tight manner;
a control electrode galvanically connected to said moving-contact current supply bolt and a conductive vapor shield disposed on said insulating body and overlapping said control electrode in an axial direction to form an overlap region;
said control electrode forming a toroid end in said overlap region with said vapor shield;
said vapor shield having a drawn-in region drawn inwardly in accordance with the toroidal shape of said control electrode; and
said moving-contact current supply bolt having a waist constriction and said drawn-in region of said vapor shield extending around said waist constriction when said contact system is in an open position.

11. The vacuum interrupter according to claim 10, wherein said waist constriction of said moving-contact current supply bolt has a contour substantially corresponding to a contour of said drawn-in region of said vapor shield.

12. The vacuum interrupter according to claim 10, wherein said waist constriction of said moving-contact current supply bolt is lengthened in an axial direction away from said moving contact by no more than a length corresponding to a stroke distance of said moving contact.

13. The vacuum interrupter according to claim 10, wherein said control electrode extends from said insulating body in a direction of said vapor shield.

14. The vacuum interrupter according to claim 10, wherein said vapor shield is formed of stainless steel.
